(19) United States
(12) Patent Application Publication
(10) Pub. No.: US 2016/0326912 A1
(43) Pub. Date: Nov. 10, 2016

(54) CONTEXTUAL INTELLIGENT ASSISTANT FOR POWER PLANT OPERATORS

(71) Applicant: GENERAL ELECTRIC COMPANY, SCHENECTADY, NY (US)

(72) Inventors: Habib K Abi-Rached, San Ramon, CA (US); Melody Yvette Ivory-Ndiaye, Seattle, WA (US); Seunghyun Lee, Duluth, GA (US); Jeng-Weei Lin, Danville, CA (US); Karl Lewis Mochel, San Francisco, CA (US); Sharoda Aurushi Paul, San Ramon, CA (US); Chih-Sung Wu, Dublin, CA (US)

(21) Appl. No.: 14/947,125

(22) Filed: Nov. 20, 2015

Related U.S. Application Data
(60) Provisional application No. 62/158,686, filed on May 8, 2015.

(51) Int. Cl. F01K 13/02; G05B 15/02; G06N 3/00; G08B 19/00

(52) U.S. Cl. CPC F01K 13/02; G08B 19/00; G05B 15/02; G06N 3/006

(57) ABSTRACT

One or more computers are used as a contextual intelligent assistant for obtaining operating condition information about a power plant, capturing at least two forms of context information about a human operator of the power plant, using the operating condition information and the context information to determine at least two of a type, a modality, a location, and a timing of at least one notification to provide for use in controlling the power plant, and providing the at least one notification to the operator and optionally to other personnel in the power plant for use in operating or maintaining the power plant.

### BACKGROUND

The subject matter disclosed herein relates generally to power plant operation and more specifically to providing recommendations and alerts to operators of power plants.

Operators of power plants work in an information-rich environment where the operators are often multi-tasking across tasks and screens to cross-reference information from various sources associated with the real-time states of a large number of assets, components, and their operational conditions. Accessing multiple silo type applications contributes to inefficiency. While multi-tasking, operators also receive a large number of alarms and interruptions, which may result in cognitive overload.

### BRIEF DESCRIPTION

It would be desirable for an operator of a power plant to have an intelligent assistant for dynamically providing relevant information, recommendations, and alerts to the operator at the right time and using the right modality and display location so that the information, recommendations, and alerts are useful and not disruptive.

In one embodiment disclosed herein, a method comprises using at least one computer as a contextual intelligent assistant for obtaining operating condition information about a power plant, capturing at least two forms of context information about a human operator of the power plant, using the operating condition information and the context information to determine at least two of a type, a modality, a location, and a timing of at least one notification to provide for use in controlling the power plant, and providing the at least one notification to the operator. The method further comprises adjusting, by the operator or other human worker, operation of the power plant in response to the at least one notification.

In another embodiment disclosed herein, a control system for a power plant comprises at least two mediums for conveying notifications, and at least one computer including software for operating as a contextual intelligent assistant by: obtaining operating condition information about the power plant, capturing at least two forms of context information about a human operator of the power plant, using the operating condition information and the context information to determine at least two of a type, a modality, a location, and a timing of at least one notification to provide for use in controlling the power plant, and providing at least one notification to the operator for use by the operator or other human worker in adjusting operation of the power plant.

### DRAWINGS

FIG. 1 is a block diagram of a power plant in accordance with an embodiment disclosed herein.

FIG. 2 is a flow chart of steps for providing instructions to an operator of the power plant of FIG. 1 in accordance with an embodiment disclosed herein.

FIG. 3 is a pictorial representation of a power plant operator positioned in front of multiple screens.

### DETAILED DESCRIPTION

Unless defined otherwise, technical and scientific terms used herein have the same meaning as is commonly understood by one of ordinary skill in the art to which this disclosure belongs. The terms “a” and “an” do not denote a limitation of quantity, but rather denote the presence of at least one of the referenced items. The term “or” is meant to be inclusive and mean one, some, or all of the listed items. The use of “including,” “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect. The term “computer,” as that term is used herein, is intended to denote any machine or combination of machines capable of performing the calculations, or computations, necessary to perform the tasks described herein. One or more computers are equipped with a combination of hardware and/or software for performing the tasks described herein. In implementations where a computer is a general purpose processor, such as may be found in a general purpose computer or workstation, a processor of the computer may access and execute non-transitory code or instructions stored in or accessed from a machine-readable medium (such as a memory unit) to implement the techniques disclosed herein. Conversely, in other embodiments a computer may include or may be a special purpose computer or application specific device and/or a cell phone, a wearable device or other mobile device where certain of the functionality discussed herein is implemented.

Modern power plants are complex systems, which sometimes operate close to various limits and constraints. Operators of power plants need to make decisions about plant operation based on a large amount of information such as plant operating conditions, weather conditions, safety hazards, and implications on power generation and pricing. Often human operators must use multiple software applications and are engaged in a variety of tasks for operating the power plants. To support operator decision-making, an intelligent assistant can provide notifications including recommendations and alerts, for example. The present disclosure describes an intelligent assistant having an effective means of presenting the notifications to an operator taking into account factors about the operator such as, for example, interruptability (or task context), cognitive load, emotional state, and/or attention. Using these operator factors and plant operation information, the presentation of the notifications at the right time and location and using the right modality such as, for example, visual, auditory, and/or tactile, is important in an information-rich, multi-screen environment where operators often experience alarm fatigue.

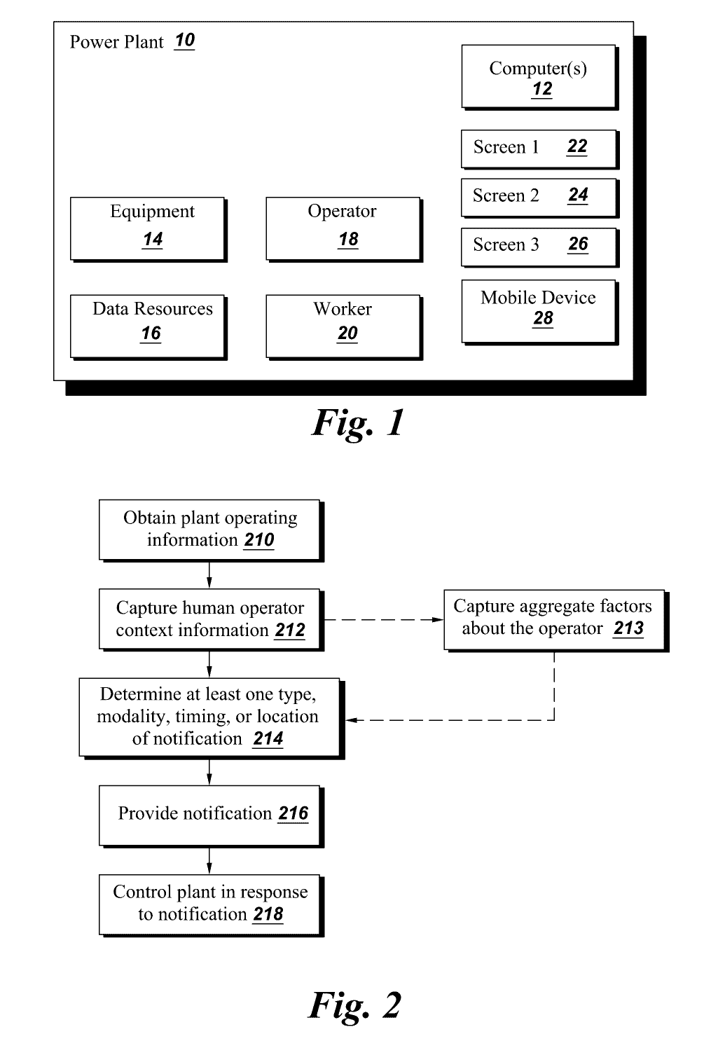

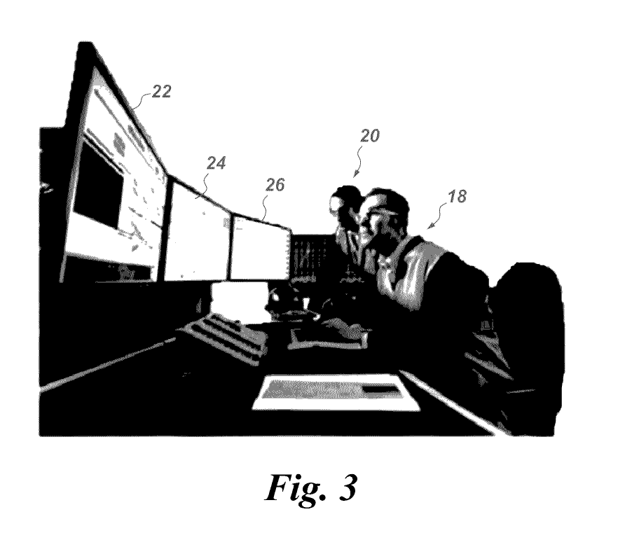

In accordance with various embodiments of the present invention, FIG. 1 is a block diagram of a power plant 10, FIG. 2 is a flow chart of steps 210-218 for providing instructions to an operator 18 of power plant 10, and FIG. 3 is a pictorial representation of a power plant operator 18 positioned in front of multiple screens 22, 24, 26. At least one computer 12 is used as a contextual intelligent assistant for obtaining operating condition information about power plant 10 (step 210), capturing at least two forms of context information about a human operator of the power plant (step 212), using the operating condition information and the context information to determine at least two of a type, a modality, a location, and a timing of at least one notification to provide for use in controlling the power plant (step 214), and providing the notification to operator 18 (step 216). There are various mediums for conveying the notifications including, for example, screens 22, 24, 26 such as shown in FIG. 3, screens on mobile devices 28 (FIG. 1), and auditory, vibratory, and tactile elements associated with computer 12 and/or mobile devices 28. Then operation of power plant 10 is adjusted by operator 18 or another human worker 20 in response to the notification (step 218).

Referring more specifically to the steps shown in FIG. 2, at step 210 plant operating information is obtained by computer 12. In one embodiment, the information is obtained from data resources 16 (FIG. 1). Data resources 16 may be used to obtain data such as market data, operating data, and/or ambient data. Market data includes information on market conditions, such as energy sales price, fuel costs, labor costs, regulations, and demand, for example. Operating data includes information relating to the operating conditions of the power plant or its generating units, such as temperature, or pressure, air flow rates, and fuel flow rates, for example, within equipment 14 (FIG. 1) of the power plant. Ambient data includes information related to ambient conditions at the plant, such as ambient air temperature, humidity, and/or pressure. Market, operating, and ambient data each may include historical records, present condition data, and/or data relating to forecasts. For example, data resources 16 may include the Internet or other remote data collection device for providing present and forecast meteorological/climate information from the Internet and/or present and forecast market conditions, power plant memory (not shown) for providing usage and performance history records about the operation of the power plant, and/or sensors (not shown) for providing measured parameters regarding the operation of power plant 10 and, in some embodiments, real-time locations and availabilities of other workers 20 in the plant.

At step 212, at least two forms of context information about a human operator 18 of power plant 10 are captured by computer 12. As used herein computer means at least one computer such that the computer obtaining the plant operating information and the computer capturing the context information may be the same machine but need not be the same machine. Additionally, in some embodiments, data or calculated information from various computers may be processed by yet another computer such as a supervisory computer for generation of the ultimate notifications.

In one embodiment, the context information captured in step 212 may comprise at least two of screen information density, number of active windows/applications, cursor movement, text input, eye gaze, speech, tone of voice, body posture, and physiological information. For example, as seen in FIG. 3, there are three screens 22, 24, 26 in front of operator 18 linked to computer 12 (FIG. 1). Information about density of information on the screen or screens and number of open applications can be obtained directly by computer 12. Computer 12 may also directly obtain information about cursor movement and/or text input by monitoring keyboard clicks and mouse/trackball activity. Eye gaze and/or body posture may be monitored by one or more cameras (not shown) positioned relative to the screens 22, 24, 26. Information about speech and/or tone of voice may be obtained by one or more auditory sensors (not shown). Physiological information about the operator such as heart-rate, blood pressure, and/or temperature may be captured using wearable devices, such as a smart watch, worn by the operator. This physiological information may be used separately or in conjunction with other context information to infer stress levels of the operator.

At step 214, computer 12 uses the operating condition information and the context information to determine at least two of the type, the modality, the location, and the timing of the notification or alert to provide for use in controlling the power plant. The operating condition information is used to assess any issues and associated severity/priority associated with those issues and may additionally be used to optimize operation of power plant 10 in a manner such as described in commonly assigned Wichmann et al., US 20150185716, for example, which is herein incorporated by reference. The context information is used in combination with the plant operating information to determine how best to convey the notification to operator 18.

At an optional step 213 between steps 212 and 214, the context information is used for calculating at least two higher level aggregate contextual factors about the operator that are then used to determine the type, the modality, the location, and/or the timing of the notification. Examples of aggregate factors about operator 18 may comprise at least two of interruptability, cognitive load, emotional state, and attention. For example, interruptability may be based at least in part on active windows/applications and/or information density of the screen. Emotional state may be based at least in part on tone of voice, body posture, and/or physiological information. Attention may be based at least in part on eye-tracking, cursor movement, and or text input. In some embodiments, historical information about the specific operator 18 is also used when determining the aggregate contextual factors. In other embodiments, the aggregate factors may be determined based only on currently obtained data.

The notifications may be generated by an underlying model in computer 12 that takes into account various relevant data such as asset operating conditions, weather information, manuals, gas prices, supply and demand data, locations and availabilities of other plant personnel in combination with the captured context information and aggregate contextual factors when making the determinations.

Determining the “type” of alert may be based on predetermined priorities assigned to different events that the operator must be made aware of Types can be alarms (high priority), alerts (medium priority), and recommendations (low priority). Alarms will typically need to be immediately addressed by the operator. Alerts warn of impending alarm conditions that might lead to serious or critical issues. Recommendations may provide ways for the operator to run the plant more efficiently and optimally, for example.

Determining the “modality” of notification refers to computer 12 performing computations for selecting among visual, auditory, and/or tactile (such as vibratory) communications. Determining the “modality” of notification may further comprise, for example, selecting the nature of the image such as size and color when using a visual mode, selecting at least one of a volume, a tone, and a pattern when using an auditory mode, and selecting at least one of an intensity or pattern when using a tactile or vibratory mode. For certain urgent notifications and/or operators exhibiting certain aggregate contextual factors, in one example, multiple modalities may be useful to ensure that that operator receives a given notification. Rules may be used to determine how to map the values of the calculated aggregate contextual factors to type, modality, and location of alerts. For example, if the assistant determines that the operator has a high cognitive load and low interruptability, it may determine that the right modality of alerts or recommendations is visual instead of auditory. In some embodiments, operators exhibiting certain values of aggregate contextual factors may require larger and bolder visual alerts and/or louder or more intense auditory or tactile alerts than other operators.

Determining the “timing” of notification may depend in part on how many notifications are generated at a given point in time. When multiple notifications are generated, the priority may be used to determine timing of providing the notifications. For example, an action requiring an immediate response may be provided on its own so that operator 18 is not distracted by seeing multiple new notifications at one time. After a period of time, then less urgent notifications may then be sent in this example. For example, if the operator has a high cognitive load, only the high priority alarms will be displayed using appropriate modality. Low priority alerts and/or recommendations will be queued to be displayed later. The assistant will determine a later time when the values of the aggregate contextual factors are favorable, to display the queued alerts and recommendations.

Various options are available for determining the “location” for the notification. If there are multiple operators 18, an initial location determination is which operator or operators will receive the notification. For example, if one operator appears to be less likely to be responsive based on the context information and/or aggregate contextual factors, more urgent notifications may be sent to another operator in addition to or instead of being sent to the less responsive operator. As another example, if the notification is one that will require another human worker 20 such as a maintenance engineer, the notification may be sent in parallel to operator 18 and the maintenance engineer. For visual notifications, another location determination is on which screen or screens to show the notification. This is particularly useful when the operator is operating in a multi-screen embodiment and a specific screen or screens need be selected on which to place the notification. Multi-screen embodiments may include, for example, the three screens 22, 24, 26 parallel to operator 18 line of sight in FIG. 3 as well as the devices closer to the desktop and the operator's hands and/or mobile devices. This may be determined based on the priority of the notification as well as based on context information and/or aggregate contextual factors of the operator. For example, higher priority matters may be positioned on each screen in front of a given operator 18 at a position most likely to be seen by the operator based on the observations about the operator. Another example is to place the alert or recommendation in areas of a screen where the operator is focused and/or the screen has low information density.

Operator 18 receives the notification at step 216, and then operator 18 or another human worker 20 adjusts operation of the power plant in response. As non-limiting examples, operator 18 may respond to the notification by adjusting at least one operating parameter of the power plant or by collaborating with another human worker 20 to shut down or fix malfunctioning equipment 14 in the power plant, for example. In one more specific embodiment, operator 18 collaborates with the worker 20 in the power plant to resolve the issue with the facilitation of the contextual intelligent assistant. As another example, the contextual intelligent assistant may in some situations send the information to both operator 18 and a worker 20 such as a maintenance engineer simultaneously and facilitate information sharing across different devices. In one embodiment, the maintenance engineer may be using a mobile device 38 such as a cell phone, a tablet, or a wearable device, whereas the operator may be looking at one or more screens 22, 24, 26 (FIG. 3) on a desk top.

Technical advantages of the embodiments disclosed herein include the facts that, by making notifications that take into account the operator's context, distractions and alarm fatigue may be reduced and that decision support may be provided for dynamically changing information. Commercial advantages of the embodiments disclosed herein include that the embodiments may be built using open software components that lower development cost and that more proactive modes of operation may be provided to the operator as opposed to more reactive modes.

While only certain features of the invention have been illustrated and described herein, many modifications and changes will occur to those skilled in the art. It is, therefore, to be understood that the appended claims are intended to cover all such modifications and changes as fall within the true spirit of the invention. Aspects from the various embodiments described, as well as other known equivalents for each such aspect, can be mixed and matched by one of ordinary skill in the art to construct additional embodiments and techniques in accordance with principles of this application. Further, the limitations of the following claims are not written in means-plus-function format and are not intended to be interpreted as being means-plus-function claims, unless and until such claim limitations expressly use the phrase “means for” followed by a statement of function void of further structure.

1. A method comprising:
(a) using at least one computer as a contextual intelligent assistant for
(i) obtaining operating condition information about a power plant,
(ii) capturing at least two forms of context information about a human operator of the power plant,
(iii) using the operating condition information and the context information to determine at least two of a modality, a type, a location, and a timing of at least one notification to provide for use in controlling the power plant, and
(iv) providing the at least one notification to the operator; and
(b) adjusting, by the operator or other human worker, operation of the power plant in response to the at least one notification.

2. The method of claim 1 wherein using the operating condition information and the context information to determine the at least two of the type, the modality, the location, and the timing of the at least one notification comprises using the context information for calculating at least two aggregate contextual factors about the operator and using the at least two aggregate contextual factors when determining the at least two of the type, the modality, the location, and the timing of the at least one notification.

3. The method of claim 2 wherein the context information comprises at least two of number of active windows/applications, screen information density, cursor movement, text input, eye gaze, speech, tone of voice, body posture, and physiological information.

4. The method of claim 3 wherein the aggregate contextual factors about the operator comprise at least two of interruptability, cognitive load, emotional state, and attention.

5. The method of claim 1 wherein determining the type of the notification comprises determining an alarm, an alert, or a recommendation.

6. The method of claim 1 wherein determining the modality of the at least one notification comprises selecting among visual, auditory, and/or tactile modes.

7. The method of claim 6 wherein determining the modality further comprises selecting the nature of the image when using a visual mode, selecting at least one of a volume, a tone, and a pattern when using an auditory mode, and selecting at least one of an intensity or pattern when using a tactile mode.

8. The method of claim 1 wherein the operator is operating in a multi-screen embodiment, and wherein determining the location of the at least one notification comprises selecting a specific screen or screens on which to place the at least one notification.

9. The method of claim 1 wherein the at least one notification comprises multiple notifications, and wherein determining the timing of the multiple notifications comprises using priorities of the multiple notifications.

10. The method of claim 1 wherein at least one of weather information, a power plant manual, energy source pricing, information regarding locations and availabilities of other personnel in the plant, supply data, and demand data is used in addition to the operating condition information and the context information when determining the at least two of the type, the modality, the location, and the timing of the at least one notification to provide for use in controlling the power plant.

11. The method of claim 1 wherein the operator collaborates with the other human worker in the power plant to resolve an issue with facilitation of the contextual intelligent assistant, wherein the other human worker comprises a maintenance engineer using a mobile device, and wherein the at least one computer provides the notification to the maintenance engineer's mobile device.

12. A control system for a power plant comprising:
(a) at least two mediums for conveying notifications; and
(b) at least one computer including software for operating as a contextual intelligent assistant by:
(i) obtaining operating condition information about the power plant,
(ii) capturing at least two forms of context information about a human operator of the power plant,
(iii) using the operating condition information and the context information to determine at least two of a type, a modality, a location, and a timing of at least one notification to provide for use in controlling the power plant, and
(iv) providing the at least one notification through at least one of the at least two mediums to the operator for use by the operator or other human worker in adjusting operation of the power plant.

13. The control system of claim 12 wherein the at least two mediums comprise at least two display screens.

14. The control system of claim 12 wherein the at least two mediums comprise at least one mobile device.

15. The control system of claim 12 wherein the software for using the operating condition information and the context information to determine the at least two of the type, the modality, the location, and the timing of at least one notification includes one or more algorithms for using the context information for calculating at least two aggregate factors about the operator and using the at least two aggregate factors when determining the at least two of the type, the modality, the location, and the timing of the at least one notification.

16. The control system of claim 15 wherein the context information comprises at least two of number of active windows/applications, screen information density, cursor movement, text input, eye gaze, speech, tone of voice, body posture, and physiological information.

17. The control system of claim 16 wherein the aggregate factors about the operator comprise at least two of interruptability, cognitive load, emotional state, and/or attention.

18. The control system of claim 12 wherein the at least one computer is programmed for determining the modality of the at least one notification by selecting among visual, auditory, and/or tactile modes.

19. The control system of claim 18 wherein the at least one computer is programmed for determining the modality of the notification by selecting the nature of the image when using a visual mode, selecting at least one of a volume, a tone, and a pattern when using an auditory mode, and selecting at least one of an intensity or pattern when using a tactile mode.

20. The control system of claim 12 wherein the at least one computer is programmed for determining the location of the at least one notification by selecting a specific medium or mediums on which to place the at least one notification.
